(19) United States
(12) Patent Application Publication
(10) Pub. No.: US 2026/0357020 A1
(43) Pub. Date: Nov. 12, 2026

(54) MULTILAYER STRUCTURES AND VESSELS CONSTRUCTED THEREFROM

(71) Applicant: OMNI TANKER TECHNOLOGY PTY LTD, Sydney, New South Wales (AU)

(72) Inventors: Daniel C RODGERS, Sydney, New South Wales (AU); Luke P DJUKIC, Sydney, New South Wales (AU)

(21) Appl. No.: 19/100,364

(22) PCT Filed: Aug. 3, 2022
(86) PCT No.: PCT/AU2022/050834

§ 371 Date: Jan. 31, 2025

(51) Int. Cl. C08J 5/24

(52) U.S. Cl. CPC C08J 5/247; C08J 2323/06; C08J 2363/10

(57) ABSTRACT

Hollow composite vessels having walls composed of multilayer structures including a thermoplastic layer, a fibrous layer, and a layer including both a plurality of filaments and thermoset polymer. The vessels are manufactured by, in part, rotomolding processes and are characterised by strong bonding between the layers of the multilayered structure. The vessels can be used for the storage and transportation of powders, liquids, gases and cryogenic substances, particularly hazardous substances.

### FIELD OF THE DISCLOSURE

The present disclosure relates to multilayer structures comprising a thermoplastic layer, a fibrous layer, and a layer comprising both a plurality of filaments and thermoset polymer. The present disclosure also relates to vessels incorporating the multilayer structures, and to manufacture of the vessels utilising rotomolding processes. The vessels may find use in the storage and transportation of materials, particularly, but not exclusively, hazardous liquids, gases and powders, and cryogenic materials.

### BACKGROUND OF THE DISCLOSURE

Tanks are widely used for the transportation of materials such as liquids, gases and powders, both hazardous and non-hazardous. For the transportation of hazardous materials the tanks must meet a number of local and international regulations.

Tanks for the transportation of hazardous materials are generally constructed from metal, which imparts structural strength, and can be lined with a resilient liner to protect the metal from the corrosive nature of the tank contents.

However, lined metal tanks have a number of disadvantages, including their excessive weight, which increases transportation costs, and the possibility over time that the liner material becomes degraded due to contact with the tank contents, or detached from the inner wall of the metal tank, necessitating liner repair or replacement.

International patent application publication no. WO 2007/093006 discloses articles of composite construction and methods of their manufacture. The articles comprise a fibrous material and a thermoplastic. The fibrous material may include glass or carbon fibres. Suitable thermoplastics include polyethylene, polypropylene, polyvinylidene fluoride and ethylene chloro trifluoro ethylene. The articles may also comprise a thermosetting polymer selected from polyester, vinylester, epoxy and polyurethane. The articles may be formed through rotomolding. However, the disclosure is general in nature, and, in particular, is silent in respect of details of how the composite articles are manufactured, details of the different components and their relationships, and on the performance of the composite articles.

Accordingly, a need remains to provide alternative structures for use in the manufacture of transportation vessels for hazardous materials.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE DISCLOSURE

In one aspect the present disclosure provides a hollow composite vessel, wherein a wall of the hollow composite vessel comprises a multilayer structure, said multilayer structure comprising:
an inner layer comprising one or more thermoplastic polymers;
an outer layer comprising a plurality of filaments selected from one or more of carbon, glass, aramid and basalt filaments, and one or more thermosetting polymers; and
a middle layer disposed between the inner layer and the outer layer, said middle layer comprising one or more fibrous materials;
wherein the one or more fibrous materials is at least partly infiltrated with both the one or more thermoplastic polymers and the one or more thermosetting polymers.

In embodiments, the one or more thermoplastic polymers of the inner layer comprise one or more of ethylene homopolymers, ethylene co-polymers, propylene homopolymers, propylene co-polymers, fluoropolymers, polyvinylchloride, polyvinylidene chloride, polyaryl ether ketone (for example polyether ether ketone) and polyamide.

In embodiments, the one or more thermosetting polymers of the outer layer comprise one or more of vinyl ester, bismaleimide, polyester, polyacrylate, epoxy, and polyurethane.

In embodiments, the one or more fibrous materials of the middle layer comprise one or more fabricated textile materials.

In embodiments, the one or more fabricated textile materials comprise one or more of woven, knitted, and braided materials.

In embodiments, the one or more fabricated textile materials comprise yarns of plied strands.

In embodiments, the spacing between at least some yarns of the fibrous material of the middle layer is from about 0.01 micron to about 5000 micron, or from about 0.1 micron to about 5000 micron, or between about 1 micron and about 5000 micron, or between about 10 micron and about 5000 micron.

In embodiments, the one or more fibrous materials of the middle layer comprise one or more of ceramic fibres and polymeric fibres.

The one or more ceramic fibres may comprise one or more of glass, carbon and basalt fibres, or precursors thereof.

The one or more polymeric fibres may comprise one or both synthetic polymers and natural polymers.

The one or more polymeric fibres may comprise one or more of polyamide and polyolefin. Suitable polyolefins include polyethylene and polypropylene.

In embodiments, the plurality of filaments of the outer layer have a filament diameter from about 0.1 micron to about 500 micron, or from about 0.1 micron to about 100 micron, or from about 0.1 micron to about 50 micron, or from about 1 micron to about 20 micron.

In embodiments, the plurality of filaments of the outer layer are in the form of one or more of wound filaments, fabric sections comprising multiple yarns, braided yarns, and chopped fibres.

In embodiments, the thickness of the inner layer of the multilayer structure is from about 0.1 mm to about 50 mm, the thickness of the middle layer is from about 0.1 mm to about 5 mm, and the thickness of the outer layer is from about 0.1 mm to about 1000 mm.

In embodiments, thermoplastic polymer is embedded in gaps between yarns of the fibrous material of the middle layer.

In embodiments, thermoplastic polymer is embedded within the structure of individual yarns of the fibrous material of the middle layer.

In embodiments, tendrils of the fibrous material of the middle layer extend from a surface of the yarns into the inner layer.

In embodiments, the strength of the union between the thermoplastic polymer and the fibrous layer is greater than the cohesive strength of the thermoplastic polymer.

In embodiments, the thermoplastic polymer is embedded in the fibrous layer to an extent such that shear failure of the multilayer structure occurs through cohesive failure of the thermoplastic polymer.

In embodiments, the multilayer structure has a maximum lap shear strength which is proportional to the tensile strength of the thermoplastic polymer.

In embodiments, the multilayer structure has a maximum lap shear strength equal to the tensile strength of the thermoplastic polymer multiplied by 0.58.

In embodiments, the lap shear strength of the multilayer structure is greater than about 3 MPa, or greater than about 4 MPa, or greater than about 5 MPa, or greater than about 6 MPa, or greater than about 7 MPa, or greater than about 8 MPa, or greater than about 9 MPa, or greater than about 10 MPa.

In embodiments, the fibrous layer has a single pressure average permeability of less than 10-11 m2.

In embodiments, the fibrous layer has a single pressure average permeability of less than about 9*10-12 m2, or less than about 8*10-12 m2, or less than about 7*10-12 m2, or less than about 6*10-12 m2, or less than about 5*10-12 m2, or less than about 4*10-12 m2.

In embodiments, the thermoplastic polymer is not completely infiltrated across a thickness of the fibrous layer. That is to say, at least a portion of the surface of the fibrous layer is not fully penetrated by the thermoplastic polymer. Preferably, substantially all of the surface of the fibrous layer is not fully penetrated by the thermoplastic polymer.

In embodiments, the hollow composite vessel is not limited by shape. In some embodiments, the hollow composite vessel is of generally spherical, cylindrical or spherocylindrical shape.

In another aspect the present disclosure provides a method of manufacturing a hollow composite vessel comprising the following steps:
a) applying one or more fibrous materials to the internal surface of a hollow mold;
b) heating and rotating the hollow mold in the presence of one more thermoplastic polymers located within the hollow mold so that the thermoplastic polymer melts and at least partially infiltrates the fibrous material;
c) cooling the mold so that the thermoplastic polymer solidifies;
d) releasing a hollow thermoplastic polymer/fibrous material composite vessel from the mold; and one or more of steps e) to g);
e) applying a plurality of filaments selected from one or more of carbon, glass, aramid and basalt filaments to the outside of the hollow thermoplastic polymer/fibrous material composite vessel, wherein prior to application the plurality of filaments are at least partly wetted with one or more thermoset polymers;
f) applying a plurality of filaments selected from one or more of carbon, glass, aramid and basalt filaments to the outside of the hollow thermoplastic polymer/fibrous material composite vessel followed by application of one or more thermoset polymers;
g) applying one or more thermoset polymers to the outside of the hollow thermoplastic polymer/fibrous material composite vessel followed by application of a plurality of filaments selected from one or more of carbon, glass, aramid and basalt filaments.

In embodiments, the method further comprises curing the one or more thermoset polymers.

In embodiments, the mold is simultaneously rotated about two directions.

In embodiments, the hollow composite vessel is of generally spherical, cylindrical or spherocylindrical shape.

In embodiments, the fibrous material may be fixed to the internal surface of the mold through, for example, mechanical or adhesive means, or through the application of pressure.

It will be appreciated that the method aspect of the present disclosure can include any one or more of the embodiments of the hollow composite vessel aspect.

Advantages of the presently disclosed hollow composite vessels include one or more of the following:
the walls of the vessels exhibit high shear strength due to the strong coupling between the middle layer and the inner and outer layers;
the inner layer provides a barrier layer for the containment of hazardous materials;
the use of a rotomolding process enables seamless integration of the inner thermoplastic polymer layer with the fibrous layer.

Any embodiment herein shall be taken to apply mutatis mutandis to any other embodiment unless specifically stated otherwise.

The present disclosure is not to be limited in scope by the specific embodiments described herein, which are intended for the purpose of exemplification only. Functionally-equivalent products, compositions and processes are clearly within the scope of the disclosure, as described herein.

Further aspects of the present disclosure and further embodiments of the aspects described in the preceding paragraphs will become apparent from the following description, given by way of example and with reference to the accompanying drawings.

### BRIEF DESCRIPTION OF THE DRAWINGS

FIG. 1(a) is a schematic drawing of a generally spherocylindrical hollow composite vessel and FIG. 1(b) is an exploded view of the multilayer wall structure, according to embodiments of the present disclosure

FIG. 2 is an illustration of thermoplastic polymer infiltrating the spaces between yarns of a woven fibrous material.

FIG. 3 is an illustration of thermoplastic polymer infiltrating the structure of a yarn of a woven fibrous material.

FIG. 4 is an illustration of thermoplastic polymer interacting with fibrils projecting from a yarn of a woven fibrous material.

FIGS. 5 (a) and (b) are micrographs of the interface between polyethylene layer and a woven fibrous layer indicating areas of infiltration of the polyethylene into the spaces between yarns of the fibrous layer.

FIG. 6 is a photograph of polyethylene adherent from lap joint testing showing fibres from a woven fibrous layer attached to the failure surface.

FIG. 7 is a photograph of the woven fibrous layer from lap joint testing showing polyethylene rich locations.

FIG. 8 is a micrograph of the interface between thermoplastic polymer layer and woven fibrous material layer highlighting fibre tendrils of the fibrous layer embedded in the thermoplastic polymer layer.

FIG. 9 is a photograph of the failure surfaces from lap joint testing of a multilayer structure with a non-woven fibrous layer showing the white coloured fibrous layer to be on both failure surfaces.

### DETAILED DESCRIPTION OF THE EMBODIMENTS

It will be understood that the disclosure described and defined in this specification extends to all alternative combinations of two or more of the individual features mentioned or evident from the text or drawings. All of these different combinations constitute various alternative aspects of the disclosure.

### DEFINITIONS

For purposes of interpreting this specification, terms used in the singular will also include the plural and vice versa.

As used herein, except where the context requires otherwise, the term “comprise” and variations of the term, such as “comprising”, “comprises” and “comprised”, are not intended to exclude further additives, components, integers or steps.

“About” as used herein when referring to a measurable value such as an amount, a temporal duration, and the like, is meant to encompass variations of ±20% or ±10%, in some instances ±5%, in some instances ±1%, and in some instances ±0.1% from the specified value, as such variations are appropriate to perform the disclosed methods.

Ranges: throughout this disclosure, various aspects of the disclosure can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

The present disclosure provides a hollow composite vessel comprising three layers, an inner layer comprising one or more thermoplastic polymers, a middle layer comprising one or more fibrous materials, and an outer layer comprising a plurality of filaments and one or more thermosetting polymers. The inventors have discovered that certain fibrous material architectures may afford multilayered structures which possess advantageous properties.

### Inner Layer—Thermoplastic Polymer

Thermoplastic polymers for use in the construction of the inner layer preferably possess resistance to a variety of substances and conditions. For example, resistance to one or more of high pH, low pH, oxidising agents, reducing agents, solvents, high pressure gas, cryogenic substances, permeation, and abrasion.

The thermoplastic polymer may comprise one or more of ethylene homopolymers, ethylene copolymers, propylene homopolymers, propylene copolymers, fluoropolymers, polyvinylchloride, polyvinylidene chloride, polyaryl ether ketone (for example polyether ether ketone) and polyamide.

The ethylene homopolymer may be a high density ethylene homopolymer or a low density ethylene homopolymer. The ethylene copolymers may be copolymers of ethylene with one or more alpha-olefins or one or more cyclic olefins. The propylene homopolymers may be polypropylene. The propylene copolymers may be copolymers of propylene and one or more alpha-olefins.

Suitable fluoropolymers include one or more of polyvinyl fluoride, polyvinylidene fluoride, polytetrafluorethylene, perfluoroalkoxy alkane, fluorinated ethylene-propylene, ethylene tetrafluoroethylene, ethylene chlorotrifluoroethylene, polyethylenetetrafluoroethylene, and polyethylenechlorotrifluoroethylene.

In embodiments, the thickness of the inner layer is from about 0.1 mm to about 50 mm, or from about 0.2 mm to about 50 mm, or from about 0.5 mm to about 50 mm, or from about 1 mm to about 50 mm, or from about 2 mm to about 50 mm, or from about 0.1 mm to about 40 mm, or from about 0.2 mm to about 30 mm, or from about 0.1 mm to about 20 mm, or from about 0.1 mm to about 10 mm, or from about 0.1 mm to about 5 mm, or from about 0.5 mm to about 40 mm, or from about 0.1 mm to about 30 mm, or from about 1 mm to about 40 mm, or from about 1 mm to about 30 mm, or from about 1 mm to about 20 mm, or from about 1 mm to about 10 mm, or from about 2 mm to about 30 mm.

### Middle Layer—Fibrous Material

In embodiments, the one or more fibrous materials of the middle layer comprise one or more fabricated textile materials.

In embodiments, the one or more fabricated textile materials comprises one or more of woven, knitted, and braided materials.

In embodiments, the one or more fabricated textile materials comprise yarns of plied strands.

In embodiments, the spacing between at least some yarns of the fibrous material of the middle layer is from about 0.01 micron to about 5000 micron, or from about 0.1 micron to about 5000 micron, or between about 1 micron and about 5000 micron, or between about 10 micron and about 5000 micron, or between about 0.01 micron and about 1000 micron, or between about 0.1 micron and about 1000 micron, or between about 1 micron and about 1000 micron, or between about 10 micron and about 1000 micron,

In embodiments, the one or more fibrous materials of the middle layer comprise one or more of ceramic fibres and polymeric fibres.

The one or more ceramic fibres may comprise one or more of glass, carbon and basalt fibres, or precursors thereof.

The one or more polymeric fibres may comprise one or both synthetic polymers and natural polymers.

The one or more polymeric fibres may comprise one or more of polyamide and polyolefin. Suitable polyolefins include polyethylene and polypropylene.

In embodiments, the thickness of the middle layer is from about 0.1 mm to about 5 mm, or from about 0.2 mm to about 5 mm, or from about 0.3 mm to about 5 mm, or from about 0.4 mm to about 5 mm, or from about 0.5 mm to about 5 mm, or from about 0.1 mm to about 4 mm, or from about 0.1 mm to about 3 mm, or from about 0.1 mm to about 2 mm, or from about 0.2 mm to about 3 mm. or from about 0.3 mm to about 3 mm.

### Outer Layer—Filaments

The plurality of filaments are comprised of one or more of carbon, glass, aramid and basalt filaments.

In embodiments, the plurality of filaments in the outer layer have a filament diameter from about 0.1 micron to about 500 micron, or from about 0.1 micron to about 100 micron, or from about 0.1 micron to about 50 micron, or from about 1 micron to about 20 micron.

In embodiments, the plurality of filaments in the outer layer are in the form of one or more of wound filaments, fabric sections comprising multiple yarns, braided yarns and chopped fibres.

### Outer Layer—Thermoset Polymer

The thermoset polymer serves as a binding polymer for the plurality of filaments in the outer layer. The one or more thermoset polymers in the outer layer may comprise one or more of polyester, polyacrylate, epoxy, vinyl ester, bismaleimide, and polyurethane.

In embodiments, the thermoset polymer comprises epoxy vinyl ester.

In embodiments, the thickness of the outer layer comprising a plurality of filaments and one or more thermosetting polymers is from about 0.1 mm to about 200 mm, or from about 0.5 mm to about 200 mm, or from about 1 mm to about 200 mm, or from about 2 mm to about 200 mm, or from about 5 mm to about 200 mm, or from about 10 mm to about 200 mm, or from about 0.1 mm to about 100 mm, or from about 0.1 mm to about 50 mm, or from about 0.5 mm to about 100 mm, or from about 0.5 mm to about 50 mm, or from about 1 mm to about 50 mm, or from about 1 mm to about 40 mmc, or from about 1 mm to about 30 mm, or from about 1 mm to about 20 mm, or from about 2 mm to about 50 mm, or from about 2 mm to about 40 mm, or from about 2 mm to about 30 mm, or from about 2 mm to about 20 mm.

In embodiments, the total thickness of the wall of the herein disclosed hollow composite vessels is from about 0.5 mm to about 250 mm, or from about 1 mm to about 200 mm, or from about 2 mm to about 200 mm, or from about 5 mm to about 200 mm, or from about 5 mm to about 150 mm, or from about 5 mm to about 100 mm, or from about 10 mm to about 150 mm, or from about 10 mm to about 100 mm, or from about 10 mm to about 50 mm.

### Method of Preparing Hollow Composite Vessel

One method of preparing the hollow composite vessel of the present disclosure makes use of, in part, rotomolding.

In an exemplary embodiment of the manufacture of a generally spherocylindrical hollow composite vessel a multi section mold may be utilised. The multisection mold may take the form of a hollow cylindrical central section and two hemispherical outer sections, which when assembled, form a hollow spherocylindrical mold,

In a first step the inner surfaces of the mold sections are coated with the fibrous layer. The fibrous layer may be attached to the mold sections inner surfaces by a number of means, including mechanical attachment. The fibrous layer may be layered up by hand or the process may be automated.

After covering the inner surfaces of the mold sections surfaces with the fibrous layer, the mold sections are assembled.

Thermoplastic polymer in, for example, the form of powder or pellets is introduced into the mold through a suitable orifice and the orifice closed.

The mold is then heated and rotated in two directions. As the mold is heated the thermoplastic polymer melts and coats the fibrous layer on the inside surface of the mold. As the thermoplastic melts it infiltrates, to at least some extent, the fibrous layer.

The mold is heated to a temperature sufficient to melt the thermoplastic polymer. It will be appreciated that the temperature will be dependent on the melting point of the thermoplastic polymer.

After a period of time the mold is cooled so that thermoplastic polymer solidifies.

The mold is then opened and a hollow thermoplastic polymer/fibrous material vessel is released.

The hollow composite vessel of the present disclosure is then completed in one or a combination of the following manners.

A plurality of filaments selected from one or more of carbon, glass, aramid and basalt filaments are applied to the outside of the hollow thermoplastic polymer/fibrous material composite vessel wherein prior to application the plurality of filaments are at least partly wetted with one or more thermoset polymers.

A plurality of filaments selected from one or more of carbon, glass, aramid and basalt filaments are applied to the outside of the hollow thermoplastic polymer/fibrous material composite vessel followed by application of one or more thermoset polymers.

One or more thermoset polymers are applied to the outside of the hollow thermoplastic polymer/fibrous material composite vessel followed by application of a plurality of filaments selected from one or more of carbon, glass, aramid and basalt filaments.

The plurality of the filaments may be in the form of yarns and/or in the form of prefabricated sheets.

The thermoset polymer is then cured. Depending on the nature of the thermosetting polymer, curing may be performed at elevated temperatures.

### The Multilayer Structure

The multilayer wall structure of the hollow composite vessels of the present disclosure possesses advantageous mechanical properties. As one application of the presently disclosed hollow composite vessels is the transportation and storage of hazardous liquids it is desirable that the wall structure has mechanical properties that mitigate the risk of failure of the structure.

The multilayered structure of the hollow composite vessels of the present disclosure may be characterised in part by the interaction of the thermoplastic polymer layer and the fibrous layer.

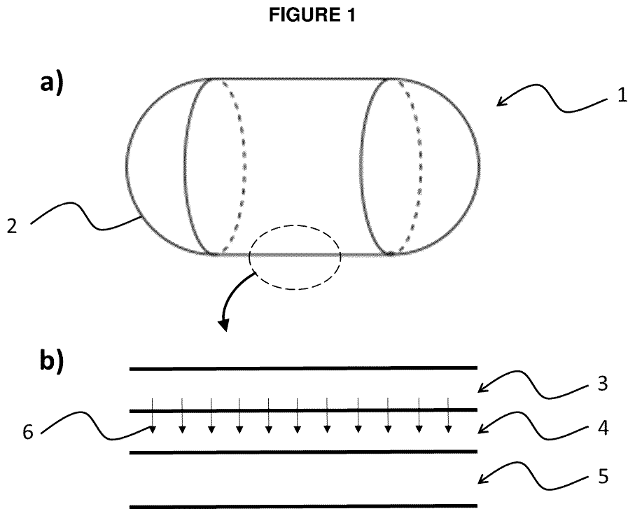

FIG. 1(a) is a schematic drawing of a generally spherocylindrical hollow composite vessel 1, having a multilayered wall structure 2, according to an embodiment of the present disclosure.

FIG. 1(b) is an exploded view of the multilayered wall structure according to an embodiment of the present disclosure illustrating inner thermoplastic polymer layer 3, middle woven fibrous layer 4, and outer layer 5 comprising a plurality of filaments and one or more thermosetting polymers. The vertical arrows 6 depict infiltration of the thermoplastic polymer partly through the thickness of the woven fibrous layer.

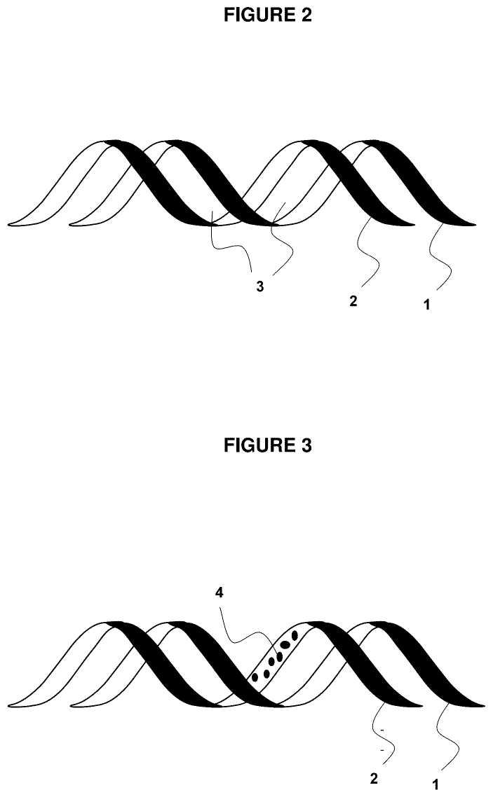

FIGS. 2, 3 and 4 illustrate three mechanisms of interaction between the thermoplastic polymer layer and the fibrous layer of the multilayer structure and which may independently contribute to the mechanical strength of the multilayer structure.

FIGS. 2, 3, and 4 illustrate a form of twisted yarn architecture according to one embodiment of the present disclosure.

A first mechanism, illustrated in FIG. 2, is characterised by gaps in the fibrous layer architecture into which the thermoplastic can flow during manufacture. FIG. 2 shows two intertwined yarns 1 and 2. The yarns are typically composed of two or more smaller fibre bundles twisted together, creating regular gaps 3 when placed up against neighbouring yarns. It is difficult to fill these gaps by the yarns themselves due to restraint within the textile, even when placed under compression. However, during melt processing the thermoplastic can flow into these gaps and once solidified within the gaps create mechanical interlock and anchoring.

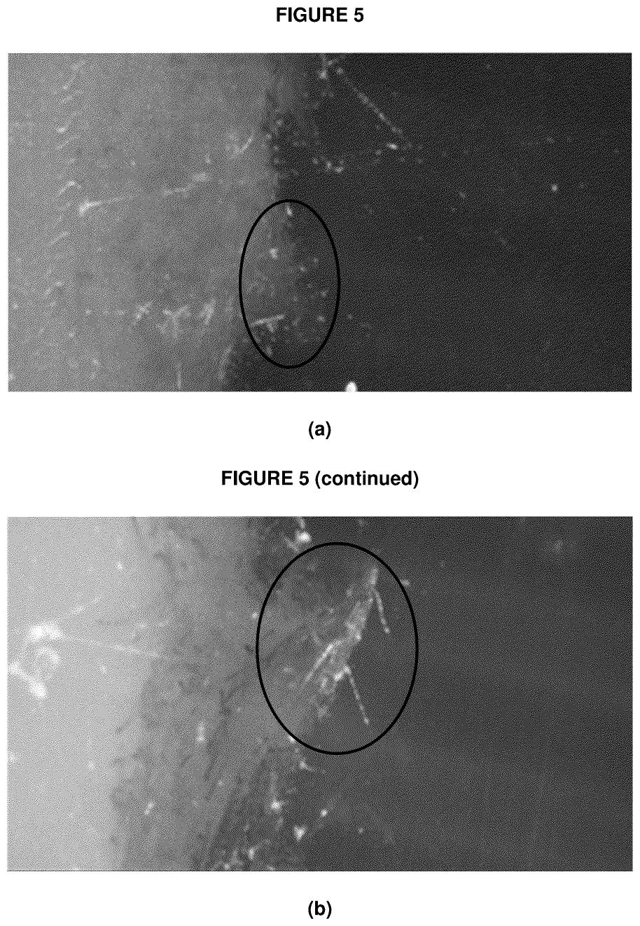

This is evidenced in FIG. 5 (a) and (b) which shows micrographs of the failure mode resulting from lap joint testing of a multilayer structure according to the present disclosure comprising a woven fibrous layer and a polyethylene thermoplastic polymer layer. Areas of thermoplastic polymer which have infiltrated gaps in the fibrous layer yarns are clearly present, as highlighted by the black ovals.

A second mechanism, illustrated in FIG. 3, is characterised by permeation of thermoplastic polymer into the structure of the yarns themselves, followed by mechanical locking upon solidification. Textile, and textile yarns, are both permeable, and thermoplastic polymer can flow into yarns during melt processing. FIG. 3 shows two intertwined yarns 1 and 2. The yarns are porous, schematically illustrated as 4. The thermoplastic polymer solidifies within the structure of the yarns, creating mechanical interlock.

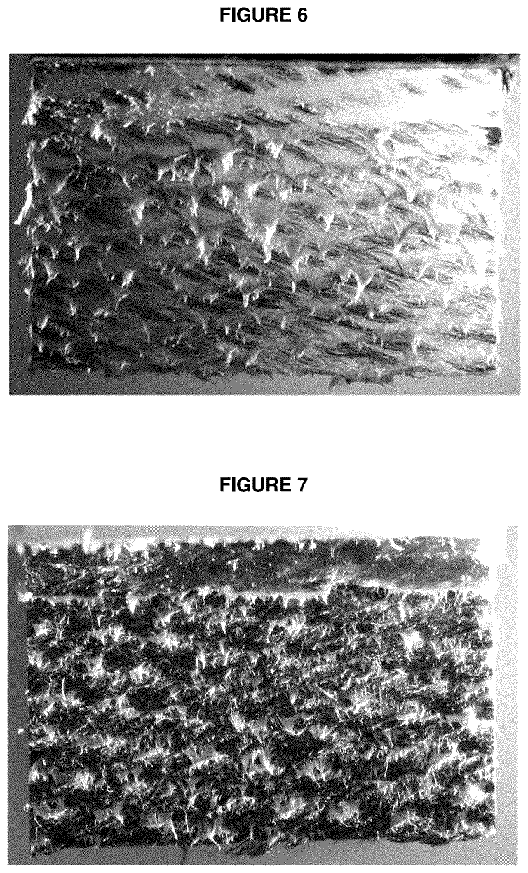

This is evidenced in FIGS. 6 and 7, which, respectively, show the surface of the polyethylene layer and the woven fibrous layer after lap joint testing. Ruptured fibres remain on the surface of the thermoplastic polymer adherends, and thermoplastic rich areas and striations are visible on the fibre layer side adherends.

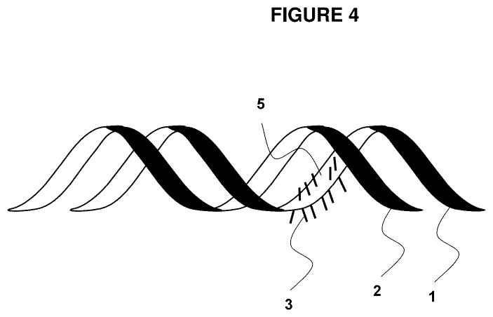

A third mechanism, illustrated in FIG. 4, is based on tendrils from yarns extending into the thermoplastic polymer layer, and extending inwards in the yarn where thermoplastic permeates, contributing to shear transfer within and around yarns. Two intertwined yarns are illustrated as 1 and 2. Tendrils 3 are illustrated extending from the bulk yarn surface and can interact with thermoplastic polymer 5 infiltrating around the tendrils.

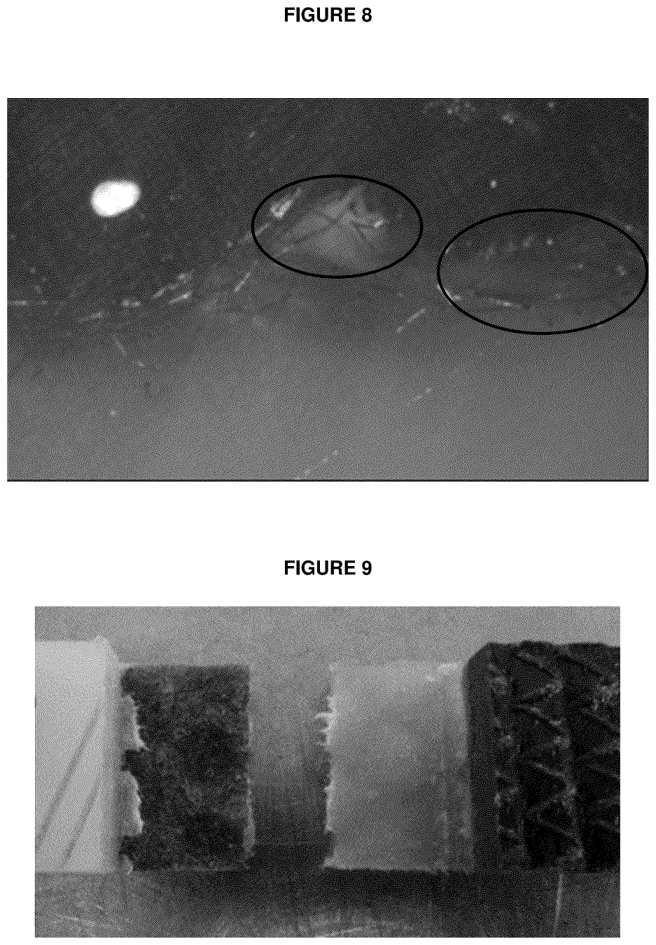

This is evidenced in the micrograph of FIG. 8, which highlights in the black ovals yarn tendrils from a woven fibrous layer embedded in polyethylene thermoplastic polymer layer.

Textile processing techniques, including stretch breaking processing, damages yarns, resulting in fraying. These broken and/or frayed fibres can extend outwards from the yarns, and further into the thermoplastic polymer layer than the yarn would if undamaged. The broken and/or frayed fibres can also extend inwards within the yarns, where thermoplastic polymer penetrates. After melt forming, and upon cooling of the thermoplastic polymer, the broken and/or frayed yarns create mechanical interlock and anchoring.

A further characterising feature of the presently disclosed multilayer structures is that, after formation of the first two layers, that is the thermoplastic polymer inner layer and the fibrous middle layer, the fibrous layer forms the surface for application of the outer layer comprising a plurality of filaments and thermosetting polymer. The thermosetting polymer advantageously penetrates the fibres of the fibrous layer, which, after curing of the thermosetting polymer, results in strong bonding between the plurality of filaments and thermoset polymer and the fibrous layer.

In some preferred embodiments, the fibrous layer has a fibre architecture that is advantageous in forming multilayered structures that possess desirable mechanical properties. For example, woven architectures comprising multiple yarns of ceramic or polymeric fibres may improve the shear strengths of the multilayered structures.

In some preferred embodiments the permeability of the fibrous layer to thermoplastic polymer infiltration is an important parameter in controlling the shear strength of the presently disclosed multilayer structures. If the permeability is too high then this may result in reduced shear strength. Relatively low permeabilities are thus desirable.

Lap shear test studies revealed that the primary failure mode for the multilayered structures of the present disclosure is within the thermoplastic layer. This is advantageous as the shear strength of the multilayered structure may be dependent on the tensile strength of the thermoplastic. Accordingly, the shear strength of the multilayered structure may be controlled by varying the nature of the thermoplastic.

Average lap shear strengths for the presently disclosed multilayer structures may be greater than about 3 MPa, or greater than about 4 MPa, or greater than about 5 MPa, or greater than about 6 MPa, or greater than about 7 MPa, or greater than about 8 MPa, or greater than about 9 MPa, or greater than about 10 MPa.

### PARTICULAR EMBODIMENTS

A hollow composite vessel, wherein a wall of the hollow composite vessel comprises a multilayer structure, said multilayer structure comprising:
an inner layer comprising one or more thermoplastic polymers selected from one or more of ethylene homopolymers, ethylene co-polymers, propylene homopolymers, propylene co-polymers, fluoropolymers, polyvinylchloride, polyvinylidene chloride, polyaryl ether ketone (for example polyether ether ketone), and polyamide;
an outer layer comprising a plurality of filaments selected from one or more of carbon, glass, aramid and basalt filaments, and one or more thermosetting polymers; and
a middle layer disposed between the inner layer and the outer layer, said middle layer comprising one or more fibrous materials in the form of fabricated textile materials;
wherein the one or more fabricated textile materials is at least partly infiltrated with both the one or more thermoplastic polymers and the one or more thermosetting polymers.

A hollow composite vessel, wherein a wall of the hollow composite vessel comprises a multilayer structure, said multilayer structure comprising:
an inner layer comprising one or more thermoplastic polymers selected from one or more of ethylene homopolymers, ethylene co-polymers, propylene homopolymers, propylene co-polymers, fluoropolymers, polyvinylchloride, polyvinylidene chloride, polyaryl ether ketone (for example polyether ether ketone), and polyamide;
an outer layer comprising a plurality of filaments selected from one or more of carbon, glass, aramid and basalt filaments, and one or more thermosetting polymers selected from one or more of polyester, polyacrylate, epoxy, vinyl ester, bismaleimide, and polyurethane; and
a middle layer disposed between the inner layer and the outer layer, said middle layer comprising one or more fibrous materials in the form of fabricated textile materials;
wherein the one or more fabricated textile materials is at least partly infiltrated with both the one or more thermoplastic polymers and the one or more thermosetting polymers.

A hollow composite vessel, wherein a wall of the hollow composite vessel comprises a multilayer structure, said multilayer structure comprising:
an inner layer comprising one or more thermoplastic polymers selected from one or more of ethylene homopolymers, ethylene co-polymers, propylene homopolymers, propylene co-polymers, fluoropolymers, polyvinylchloride, polyvinylidene chloride, polyaryl ether ketone (for example polyether ether ketone), and polyamide;
an outer layer comprising a plurality of filaments selected from one or more of carbon, glass, aramid and basalt filaments, and one or more thermosetting polymers selected from one or more of polyester, polyacrylate, epoxy, vinyl ester, bismaleimide, and polyurethane; and
a middle layer disposed between the inner layer and the outer layer, said middle layer comprising one or more fibrous materials in the form of fabricated textile materials;
wherein the one or more fabricated textile materials is at least partly infiltrated with both the one or more thermoplastic polymers and the one or more thermosetting polymers and;
wherein the thickness of the inner layer of the multilayer structure is from about 0.1 mm to about 50 mm, the thickness of the middle layer is from about 0.1 mm to about 5 mm, and the thickness of the outer layer is from about 2 mm to about 500 mm.

A hollow composite vessel, wherein a wall of the hollow composite vessel comprises a multilayer structure, said multilayer structure comprising:
an inner layer comprising one or more thermoplastic polymers selected from one or more of ethylene homopolymers, ethylene co-polymers, propylene homopolymers, propylene co-polymers, fluoropolymers, polyvinylchloride, polyvinylidene chloride, polyaryl ether ketone (for example polyether ether ketone), and polyamide;
an outer layer comprising a plurality of filaments selected from one or more of carbon, glass, aramid and basalt filaments, and one or more thermosetting polymers selected from one or more of polyester, polyacrylate, epoxy, vinyl ester, bismaleimide, and polyurethane; and
a middle layer disposed between the inner layer and the outer layer, said middle layer comprising one or more fibrous materials in the form of fabricated textile materials;
wherein the one or more fabricated textile materials is at least partly infiltrated with both the one or more thermoplastic polymers and the one or more thermosetting polymers;
wherein the thickness of the inner layer of the multilayer structure is from about 0.1 mm to about 10 mm, the thickness of the middle layer is from about 0.1 mm to about 5 mm, and the thickness of the outer layer is from about 2 mm to about 500 mm; and
wherein the lap shear strength of the multilayer structure is greater than about 5 MPa.

A hollow composite vessel, wherein a wall of the hollow composite vessel comprises a multilayer structure, said multilayer structure comprising:
an inner layer comprising one or more thermoplastic polymers selected from one or more of ethylene homopolymers, ethylene co-polymers, propylene homopolymers, propylene co-polymers, fluoropolymers, polyvinylchloride, polyvinylidene chloride, polyaryl ether ketone (for example polyether ether ketone), and polyamide;
an outer layer comprising a plurality of filaments selected from one or more of carbon, glass, aramid and basalt filaments, and one or more thermosetting polymers selected from one or more of polyester, polyacrylate, epoxy, vinyl ester, bismaleimide, and polyurethane; and
a middle layer disposed between the inner layer and the outer layer, said middle layer comprising one or more fibrous materials in the form of fabricated textile materials;
wherein the one or more fabricated textile materials is at least partly infiltrated with both the one or more thermoplastic polymers and the one or more thermosetting polymers;
wherein the thickness of the inner layer of the multilayer structure is from about 0.1 mm to about 10 mm, the thickness of the middle layer is from about 0.2 mm to about 3 mm, and the thickness of the outer layer is from about 2 mm to about 500 mm.

In embodiments, the lap shear strength of the multilayer structure is greater than about 5 MPa.

In any one of the herein disclosed embodiments, the lap shear strength of the multilayer structure is greater than about 6 MPa, or greater than about 7 MPa, or greater than about 8 MPa, or greater than about 9 MPa, or greater than about 10 MPa.

### Use of Vessels

The presently disclosed hollow composite vessels find a wide range of application in the storage and transportation of materials, where structural strength and chemical containment are both desirable. For example, in the storage and transportation of corrosive chemicals, such as strong acids and bases, hydrogen peroxide and the like, and also for the storage and transport of high pressure gas and cryogenic substances.

### EXAMPLES

### Example 1: Manufacture of Hollow Composite Vessel

A three part mold comprising a middle section of generally cylindrical shape and two end sections of generally hemispherical shape were lined on their inside surfaces with a fibrous layer of woven fabric (an example of a fabricated textile material).

The mold sections were then assembled to afford a hollow spherocylindrical mold.

The mold was transferred to a rotomolding unit and a particular mass of thermoplastic polymer powder (polyethylene) was added to the internal cavity of the mold. The mold was then rotated and heated to a temperature sufficient to allow the thermoplastic polymer to melt and cover the surface of the fibrous layer lining the inside surface of the mold. After a period of time, heating was stopped and as the mold and its contents cooled, the thermoplastic polymer solidified so as to provide a smooth continuous layer of solid thermoplastic on the surface of the fibrous layer lining the internal surface of the mold.

The mold was then opened and a hollow vessel having a wall defined by two layers was released. The inner layer comprised the solidified thermoplastic polyethylene and the outer layer comprised the fibrous material.

The fibrous layer of the so-produced hollow vessel was then treated with epoxy vinyl ester thermoset polymer and the polymer allowed to harden. Layers of carbon fibre filaments and epoxy vinyl ester were then applied to the outside of the vessel and the thermoset polymer allowed to harden.

### Example 2

The method of Example 1 was followed except that the woven fibrous layer was replaced by a non-woven fibrous layer (an example of a non-fabricated textile material).

### Example 3: Mechanical Testing

A number of vessels comprising an inner polyethylene layer, a middle fibrous layer, and an outer layer comprising a plurality of filaments and thermoset polymer were prepared according to Example 1 and Example 2.

The thickness of the polyethylene inner layer was about 10 mm and the thickness of the outer layer comprising the plurality of filaments and thermoset polymer was about 10 mm.

The total thickness of the multilayer structures was about 20 mm.

Panels of the walls of the vessels were cut and removed for testing. Panels were typically 200 mm in length and 20 mm in breadth.

The panels were prepared for lap shear testing by cutting two slots each 5 mm from the centreline, one on the outer layer of carbon fibres and the other on the inner polyethylene layer. The first slot was cut through the carbon fibre layer and fibrous material middle layer until the polyethylene layer became visible. The panel was flipped and a slot cut through the polyethylene layer until the fibrous material middle layer became visible.

Lap shear strengths of the slotted panels were measured using a universal tensile testing apparatus following BS EN 13121-3:2008 section D.8.

The multilayered structures formed by the method of Example 2 afforded lap shear strengths between about 1.5 MPa and about 2.8 MPa.

In contrast the multilayered structures formed by the method of Example 1 afforded lap shear strengths between about 9.4 MPa and about 11.5 MPa.

The lap shear strengths of the multilayered structures of Example 1 were indicative of cohesive failure of the polyethylene (see for example FIGS. 5 and 6) whereas the much lower lap shear strengths of the multilayered structures of Example 2 indicated shear failure well below the cohesive strength of the polyethylene. See FIG. 9, which shows the white coloured fibrous layer to be on both failure surfaces indicating shear failure occurred within the fibrous layer.

Accordingly, there is a clear advantage in utilising a woven fibrous layer which, when infiltrated with thermoplastic polymer, such as polyethylene, produces a multilayer structure which has a significantly higher lap shear strength.

### Example 4—Permeability Studies

The single pressure permeabilities (K) of four fibrous layers were determined by flowing a fluid of known viscosity through a known thickness of fibrous layer and measuring the pressure drop.

The studies were performed in equipment and using methods described in DE102013102486. The permeability was calculated using Darcy's law, based on the following equation:

$$Q = \frac{K \cdot Δ p \cdot A}{v \cdot Δ L}$$

wherein
K is the fibrous layer permeability in m².
Q is the flow rate of the fluid through the fibrous layer in m³/s.
Δp is the pressure drop across the fibrous layer in Pa.
A is the measurement location area in m².
v is the kinematic viscosity of the fluid in m²/s.
ΔL is the length of flow of the fluid into the fibrous layer in m.

It is noted that the distance travelled by the fluid through the fibrous layer is equal to the time over which measurements are taken multiplied by the flow rate.

Measurements were made in triplicate and the average of the results are collected in the Table below.

| | Single pressure | Normalised |
|---|---|---|
| | average | permeability to non- |
| Fibrous layer | permeability (m²) | woven fibre |
| Non-woven fibre | 1.04 * 10⁻¹¹ | 1.00 |
| (as in Example 2) | | |
| Woven ceramic | 2.64 * 10⁻¹² | 0.25 |
| fibre (as in | | |
| Example 1) | | |
| Woven polymeric | 1.83 * 10⁻¹² | 0.18 |
| fibre (as in | | |
| Example 1) | | |
| Woven ceramic | 4.10 * 10⁻¹³ | 0.04 |
| fibre (as in | | |
| Example 1) | | |

The single pressure average permeability of the woven fibrous layer was significantly lower than that of the non-woven fibrous layer. This suggests that higher resistance to permeation of molten thermoplastic polymer into the fibrous layer during multilayer structure manufacture is advantageous in affording multilayered structures having higher lap shear strength.

1. A hollow composite vessel, wherein a wall of the hollow composite vessel comprises a multilayer structure, said multilayer structure comprising:
an inner layer comprising one or more thermoplastic polymers;
an outer layer comprising a plurality of filaments selected from one or more of carbon, glass, aramid and basalt filaments, and one or more thermosetting polymers; and
a middle layer disposed between the inner layer and the outer layer, said middle layer comprising one or more fibrous materials;
wherein the one or more fibrous materials is at least partly infiltrated with both the one or more thermoplastic polymers and the one or more thermosetting polymers.

2. The hollow composite vessel according to claim 1, wherein the one or more thermoplastic polymers of the inner layer comprise one or more of ethylene homopolymers, ethylene co-polymers, propylene homopolymers, propylene co-polymers, fluoropolymers, polyvinylchloride, polyvinylidene chloride, polyaryl ether ketone, and polyamide.

3. The hollow composite vessel according to claim 1 or claim 2, wherein the one or more thermoplastic polymers comprise polyethylene.

4. The hollow composite vessel according to claim 1 or claim 2, wherein the one or more thermoplastic polymers comprise ethylene tetrafluoroethylene.

5. The hollow composite vessel according to claim 1 or claim 2, wherein the one or more thermoplastic polymers comprise ethylene chlorotrifluoroethylene.

6. The hollow composite vessel according to any one of claims 1 to 5, wherein the one or more thermosetting polymers of the outer layer comprise one or more of polyester, polyacrylate, epoxy, vinyl ester, bismaleimide, and polyurethane.

7. The hollow composite vessel according to any one of claims 1 to 6, wherein the one or more fibrous materials of the middle layer comprises one or more fabricated textile materials.

8. The hollow composite vessel according to claim 7, wherein the one or more fabricated textile materials comprise one or more of woven, knitted, and braided materials.

9. The hollow composite vessel according to claim 7 or claim 8, wherein the one or more fabricated textile materials comprise yarns of plied strands.

10. The hollow composite vessel according to claim 9, wherein the spacing between at least some yarns of the fibrous material of the middle layer is from about 0.01 micron to about 5000 micron, or from about 0.1 micron to about 5000 micron, or between about 1 micron and about 5000 micron, or between about 10 micron and about 5000 micron.

11. The hollow composite vessel according to any one of claims 1 to 10, wherein the one or more fibrous materials of the middle layer comprise one or more of ceramic fibres and polymeric fibres.

12. The hollow composite vessel according to claim 11, wherein the one or more ceramic fibres comprise one or more of glass, carbon and basalt fibres, or precursors thereof.

13. The hollow composite vessel according to claim 11, wherein the one or more polymeric fibres comprise one or both synthetic polymers and natural polymers.

14. The hollow composite vessel according to claim 11, wherein the one or more polymeric fibres comprise one or more of polyamide and polyolefin.

15. The hollow composite vessel according to any one of claims 1 to 14, wherein the plurality of filaments of the outer layer have a filament diameter from about 0.1 micron to about 500 micron, or from about 0.1 micron to about 100 micron, or from about 0.1 micron to about 50 micron, or from about 1 micron to about 20 micron.

16. The hollow composite vessel according to any one of claims 1 to 15, wherein the plurality of filaments of the outer layer are in the form of one or more of wound filaments, fabric sections comprising multiple yarns, braided yarns and chopped fibres.

17. The hollow composite vessel according to any one of claims 1 to 16, wherein the thickness of the inner layer of the multilayer structure is from about 0.1 mm to about 50 mm, the thickness of the middle layer is from about 0.1 mm to about 5 mm, and the thickness of the outer layer is from about 0.1 mm to about 1000 mm.

18. The hollow composite vessel according to any one of claims 1 to 17, wherein the thickness of the inner layer of the multilayer structure is from about 0.2 mm to about 30 mm.

19. The hollow composite vessel according to any one of claims 1 to 18, wherein the thickness of the middle layer is from about 0.2 mm to about 3 mm.

20. The hollow composite vessel according to any one of claims 1 to 19, wherein the thickness of the outer layer is from about 2 mm to about 30 mm.

21. The hollow composite vessel according to any one of claims 1 to 20, wherein the total thickness of the wall of the hollow composite vessel is from about 5 mm to about 1000 mm.

22. The hollow composite vessel according to any one of claims 1 to 21, wherein thermoplastic polymer is embedded in gaps between yarns of the fibrous material.

23. The hollow composite vessel according to any one of claims 1 to 22, wherein thermoplastic polymer is embedded within the structure of individual yarns of the fibrous material.

24. The hollow composite vessel according to any one of claims 1 to 23, wherein tendrils of the fibrous material of the middle layer extend from a surface of yarns into the inner layer.

25. The hollow composite vessel according to any one of claims 1 to 24, wherein the strength of the union between the thermoplastic polymer and the fibrous layer is greater than the cohesive strength of the thermoplastic polymer.

26. The hollow composite vessel according to any one of claims 1 to 25, wherein the thermoplastic polymer is embedded in the fibrous layer to an extent such that shear failure of the multilayer structure occurs through cohesive failure of the thermoplastic polymer.

27. The hollow composite vessel according to any one of claims 1 to 26, wherein the multilayer structure has a maximum lap shear strength which is proportional to the tensile strength of the thermoplastic polymer.

28. The hollow composite vessel according to any one of claims 1 to 27, wherein the multilayer structure has a maximum lap shear strength substantially equal to the tensile strength of the thermoplastic polymer multiplied by 0.58.

29. The hollow composite vessel according to any one of claims 1 to 28, wherein the lap shear strength of the multilayer structure is greater than about 5 MPa.

30. The hollow composite vessel according to any one of claims 1 to 29, wherein the lap shear strength of the multilayer structure is greater than about 6 MPa.

31. The hollow composite vessel according to any one of claims 1 to 30, wherein the lap shear strength of the multilayer structure is greater than about 7 MPa.

32. The hollow composite vessel according to any one of claims 1 to 31, wherein the lap shear strength of the multilayer structure is greater than about 8 MPa.

33. The hollow composite vessel according to any one of claims 1 to 32, wherein the lap shear strength of the multilayer structure is greater than about 9 MPa.

34. The hollow composite vessel according to any one of claims 1 to 33, wherein the lap shear strength of the multilayer structure is greater than about 10 MPa.

35. The hollow composite vessel according to any one of claims 1 to 34, wherein the fibrous layer has a single pressure average permeability of less than about 10-11 m².

36. The hollow composite vessel according to any one of claims 1 to 35, wherein the fibrous layer has a single pressure average permeability of less than about 9*10⁻¹² m², or less than about 8*10⁻¹² m², or less than about 7*10⁻¹² m², or less than about 6*10⁻¹² m², or less than about 5*10⁻¹² m², or less than about 4*10⁻¹² m².

37. The hollow composite vessel according to any one of claims 1 to 36, wherein the hollow composite vessel is of generally spherical, cylindrical or spherocylindrical shape.

38. A method of manufacturing a hollow composite vessel comprising the following steps:
a) applying one or more fibrous materials to the internal surface of a hollow mold;
b) heating and rotating the hollow mold in the presence of one more thermoplastic polymers located within the hollow mold so that the thermoplastic polymer melts and at least partially infiltrates the fibrous material;
c) cooling the mold so that the thermoplastic polymer solidifies;
d) releasing a hollow thermoplastic polymer/fibrous material composite vessel from the mold; and one or more of steps e) to g);
e) applying a plurality of filaments selected from one or more of carbon, glass, aramid and basalt filaments to the outside of the hollow thermoplastic polymer/fibrous material composite vessel, wherein prior to application the plurality of filaments are at least partly wetted with one or more thermoset polymers;
f) applying a plurality of filaments selected from one or more of carbon, glass, aramid and basalt filaments to the outside of the hollow thermoplastic polymer/fibrous material composite vessel followed by application of one or more thermoset polymers;
g) applying one or more thermoset polymers to the outside of the hollow thermoplastic polymer/fibrous material composite vessel followed by application of a plurality of filaments selected from one or more of carbon, glass, aramid and basalt filaments.

39. The method according to claim 38, further comprising curing the one or more thermoset polymers.

40. The method according to claim 38 or claim 39, wherein the mold is simultaneously rotated about two directions.

41. The method according to any one of claims 38 to 40, wherein the hollow composite vessel is of generally spherical, cylindrical or spherocylindrical shape.

42. The method according to any one of claims 38 to 41, wherein the fibrous material is fixed to the internal surface of the mold through mechanical or adhesive means, or through the application of pressure.

43. The method according to any one of claims 38 to 42, wherein the one or more thermoplastic polymers comprise one or more of ethylene homopolymers, ethylene co-polymers, propylene homopolymers, propylene co-polymers, fluoropolymers, polyvinylchloride, polyvinylidene chloride, polyaryl ether ketone, and polyamide.

44. The method according to any one of claims 38 to 43, wherein the one or more thermoplastic polymers comprise polyethylene.

45. The method according to any one of claims 38 to 43, wherein the one or more thermoplastic polymers comprise ethylene tetrafluoroethylene.

46. The method according to any one of claims 38 to 43, wherein the one or more thermoplastic polymers comprise ethylene chlorotrifluoroethylene.

47. The method according to any one of claims 38 to 46, wherein the one or more thermosetting polymers comprise one or more of polyester, polyacrylate, epoxy, vinyl ester, bismaleimide, and polyurethane.

48. The method according to any one of claims 38 to 47, wherein the one or more fibrous materials comprise one or more fabricated textile materials.

49. The method according to claim 48, wherein the one or more fabricated textile materials comprise one or more of woven, knitted, and braided materials.

50. The method according to claim 48 or claim 49, wherein the one or more fabricated textile materials comprise yarns of plied strands.

51. The method according to any one of claims 38 to 50, wherein the one or more fibrous materials comprise one or more of ceramic fibres and polymeric fibres.

52. The method according to claim 51, wherein the one or more ceramic fibres comprise one or more of glass, carbon and basalt fibres, or precursors thereof.

53. The method according to claim 51, wherein the one or more polymeric fibres comprise one or both synthetic polymers and natural polymers.

54. The method according to claim 51, wherein the one or more polymeric fibres comprise one or more of polyamide and polyolefin.

55. The method according to any one of claims 38 to 54, wherein the plurality of filaments have a filament diameter from about 0.1 micron to about 500 micron, or from about 0.1 micron to about 100 micron, or from about 0.1 micron to about 50 micron, or from about 1 micron to about 20 micron.

56. The method according to any one of claims 38 to 55, wherein the plurality of filaments are in the form of one or more of wound filaments, fabric sections comprising multiple yarns, braided yarns and chopped fibres.

57. A hollow composite vessel according to claim 1, wherein a wall of the hollow composite vessel comprises a multilayer structure, said multilayer structure comprising:
an inner layer comprising one or more thermoplastic polymers selected from one or more of ethylene homopolymers, ethylene co-polymers, propylene homopolymers, propylene co-polymers, fluoropolymers, polyvinylchloride, polyvinylidene chloride, polyaryl ether ketone, and polyamide;
an outer layer comprising a plurality of filaments selected from one or more of carbon, glass, aramid and basalt filaments, and one or more thermosetting polymers; and
a middle layer disposed between the inner layer and the outer layer, said middle layer comprising one or more fibrous materials in the form of fabricated textile materials;
wherein the one or more fabricated textile materials is at least partly infiltrated with both the one or more thermoplastic polymers and the one or more thermosetting polymers.

58. A hollow composite vessel according to claim 1, wherein a wall of the hollow composite vessel comprises a multilayer structure, said multilayer structure comprising:
an inner layer comprising one or more thermoplastic polymers selected from one or more of ethylene homopolymers, ethylene co-polymers, propylene homopolymers, propylene co-polymers, fluoropolymers, polyvinylchloride, polyvinylidene chloride, polyaryl ether ketone, and polyamide;
an outer layer comprising a plurality of filaments selected from one or more of carbon, glass, aramid and basalt filaments, and one or more thermosetting polymers selected from one or more of polyester, polyacrylate, epoxy, vinyl ester, bismaleimide, and polyurethane; and
a middle layer disposed between the inner layer and the outer layer, said middle layer comprising one or more fibrous materials in the form of fabricated textile materials;
wherein the one or more fabricated textile materials is at least partly infiltrated with both the one or more thermoplastic polymers and the one or more thermosetting polymers.

59. A hollow composite vessel according to claim 1, wherein a wall of the hollow composite vessel comprises a multilayer structure, said multilayer structure comprising:
an inner layer comprising one or more thermoplastic polymers selected from one or more of ethylene homopolymers, ethylene co-polymers, propylene homopolymers, propylene co-polymers, fluoropolymers, polyvinylchloride, polyvinylidene chloride, polyaryl ether ketone, and polyamide;
an outer layer comprising a plurality of filaments selected from one or more of carbon, glass, aramid and basalt filaments, and one or more thermosetting polymers selected from one or more of polyester, polyacrylate, epoxy, and vinyl ester, bismaleimide, polyurethane; and
a middle layer disposed between the inner layer and the outer layer, said middle layer comprising one or more fibrous materials in the form of fabricated textile materials;
wherein the one or more fabricated textile materials is at least partly infiltrated with both the one or more thermoplastic polymers and the one or more thermosetting polymers; and
wherein the thickness of the inner layer of the multilayer structure is from about 0.1 mm to about 50 mm, the thickness of the middle layer is from about 0.1 mm to about 5 mm, and the thickness of the outer layer is from about 2 mm to about 500 mm.

60. A hollow composite vessel according to claim 1, wherein a wall of the hollow composite vessel comprises a multilayer structure, said multilayer structure comprising:
an inner layer comprising one or more thermoplastic polymers selected from one or more of ethylene homopolymers, ethylene co-polymers, propylene homopolymers, propylene co-polymers, fluoropolymers, polyvinylchloride, polyvinylidene chloride, polyaryl ether ketone, and polyamide;
an outer layer comprising a plurality of filaments selected from one or more of carbon, glass, aramid and basalt filaments, and one or more thermosetting polymers selected from one or more of polyester, polyacrylate, epoxy, vinyl ester, bismaleimide, and polyurethane; and
a middle layer disposed between the inner layer and the outer layer, said middle layer comprising one or more fibrous materials in the form of fabricated textile materials;
wherein the one or more fabricated textile materials is at least partly infiltrated with both the one or more thermoplastic polymers and the one or more thermosetting polymers;
wherein the thickness of the inner layer of the multilayer structure is from about 0.1 mm to about 50 mm, the thickness of the middle layer is from about 0.1 mm to about 5 mm, and the thickness of the outer layer is from about 2 mm to about 500 mm; and
wherein the lap shear strength of the multilayer structure is greater than about 5 MPa.

61. A hollow composite vessel according to claim 1, wherein a wall of the hollow composite vessel comprises a multilayer structure, said multilayer structure comprising:
an inner layer comprising one or more thermoplastic polymers selected from one or more of ethylene homopolymers, ethylene co-polymers, propylene homopolymers, propylene co-polymers, fluoropolymers, polyvinylchloride, polyvinylidene chloride, polyaryl ether ketone, and polyamide;
an outer layer comprising a plurality of filaments selected from one or more of carbon, glass, aramid and basalt filaments, and one or more thermosetting polymers selected from one or more of polyester, polyacrylate, epoxy, vinyl ester, bismaleimide, and polyurethane; and
a middle layer disposed between the inner layer and the outer layer, said middle layer comprising one or more fibrous materials in the form of fabricated textile materials;
wherein the one or more fabricated textile materials is at least partly infiltrated with both the one or more thermoplastic polymers and the one or more thermosetting polymers;
wherein the thickness of the inner layer of the multilayer structure is from about 0.1 mm to about 50 mm, the thickness of the middle layer is from about 0.1 mm to about 5 mm, and the thickness of the outer layer is from about 2 mm to about 500 mm; and
wherein the fibrous layer has a single pressure average permeability of less than about 10⁻¹¹ m².

62. A hollow composite vessel according to claim 1, wherein a wall of the hollow composite vessel comprises a multilayer structure, said multilayer structure comprising:
an inner layer comprising one or more thermoplastic polymers selected from one or more of ethylene homopolymers, ethylene co-polymers, propylene homopolymers, propylene co-polymers, fluoropolymers, polyvinylchloride, polyvinylidene chloride, polyaryl ether ketone, and polyamide;
an outer layer comprising a plurality of filaments selected from one or more of carbon, glass, aramid and basalt filaments, and one or more thermosetting polymers selected from one or more of polyester, polyacrylate, epoxy, vinyl ester, bismaleimide, and polyurethane; and
a middle layer disposed between the inner layer and the outer layer, said middle layer comprising one or more fibrous materials in the form of fabricated textile materials;
wherein the one or more fabricated textile materials is at least partly infiltrated with both the one or more thermoplastic polymers and the one or more thermosetting polymers;
wherein the thickness of the inner layer of the multilayer structure is from about 0.1 mm to about 50 mm, the thickness of the middle layer is from about 0.1 mm to about 5 mm, and the thickness of the outer layer is from about 2 mm to about 500 mm; and
wherein the multilayer structure has a maximum lap shear strength which is proportional to the tensile strength of the thermoplastic polymer.
